(19) United States
(12) Patent Application Publication
(10) Pub. No.: US 2020/0241317 A1
(43) Pub. Date: Jul. 30, 2020

(54) DISPLAY DEVICE

(71) Applicant: KABUSHIKI KAISHA TOKAI RIKA DENKI SEISAKUSHO, Aichi (JP)

(72) Inventor: Mitsuru NARUSE, Niwa-gun (JP)

(73) Assignee: Kabushiki Kaisha Tokai Rika Denki Seisakusho, Aichi (JP)

(21) Appl. No.: 16/644,091

(22) PCT Filed: Sep. 14, 2018
(86) PCT No.: PCT/JP2018/034301

§ 371 Date: Mar. 3, 2020

(30) Foreign Application Priority Data
Sep. 19, 2017 (JP) 2017-179158

(51) Int. Cl. G02B 30/52; G02B 26/02; B60K 35/00

(52) U.S. Cl. CPC G02B 30/52; G02B 26/02; B60K 35/00; B60K 2370/1531; B60K 2370/779; B60K 2370/172; B60K 2370/25; B60K 2370/178; B60K 2370/166

(57) ABSTRACT

A display device includes a first polarizing plate including a first polarization region and a first design region, a second polarizing plate including a second polarization region and a second design region, and a third polarizing plate including a third polarization region. A transmittance of light oscillating in a first direction of the polarization regions is maximized, and the design regions are transparent to light regardless of the oscillation direction of light. The first and second polarizing plates are arranged at a distance from each other along a path of the light, the first direction in the first polarization region and the first direction in the second polarization region are different from each other. The third polarizing plate is arranged such that the first direction in the third polarization region is positioned between the first direction in the first polarization region and the first direction in the second polarization region.

### CROSS-REFERENCES TO RELTED APPLICATIONS

The present application claims the priority of Japanese patent application No. 2017/179158 filed on Sep. 19, 2017, and the entire contents of Japanese patent application No. 2017/179158 are hereby incorporated by reference.

### TECHNICAL FIELD

The invention relates to a display device.

### BACKGROUND ART

A display panel with switching function is known, which is provided with a display unit which has plural polarizing plates and at least one optical element with a patterned phase difference which are stacked on the optical axis in a state that the optical element is sandwiched between the polarizing plates, and a display switching unit for switching display between plural phase difference patterns by rotating at least one of the polarizing plates and the optical element about the optical axis (see, e.g., Patent Literature 1).

The display switching unit switches the display by rotation of the display unit caused by an external operation performed on the display unit.

### CITATION LIST

### Patent Literature

Patent Literature 1: JP 2013/11795 A

### SUMMARY OF INVENTION

### Technical Problem

The display panel disclosed in Patent Literature 1 can display a two-dimensional design but may cause a problem that it has difficulty displaying a three-dimensional design.

It is an object of the invention to provide a display device which can display a three-dimensional design.

### Solution to Problem

According to an aspect of the invention, a display device is provided which comprises:
polarization regions having a light transmittance varying from a first direction to a second direction orthogonal to the first direction depending on an oscillation direction of light such that a transmittance of light oscillating in the first direction is maximized and light oscillating in the second direction is blocked;
design regions that are transparent to light regardless of the oscillation direction of light;
a first polarizing plate comprising a first polarization region as one of the polarization regions and a first design region as one of the design regions;
a second polarizing plate comprising a second polarization region as one of the polarization regions and a second design region as one of the design regions; and
a third polarizing plate comprising a third polarization region as one of the polarization regions,
wherein the first polarizing plate and the second polarizing plate are arranged at a distance from each other along a path of the light, the first direction in the first polarization region and the first direction in the second polarization region are different from each other, and
wherein the third polarizing plate is arranged such that the first direction in the third polarization region is positioned between the first direction in the first polarization region and the first direction in the second polarization region.

### Advantageous Effects of Invention

According to an embodiment of the invention, it is possible to provide a display device which can display a three-dimensional design.

### BRIEF DESCRIPTION OF DRAWINGS

FIG. 1A is an exploded view showing a display device in the first embodiment.

FIG. 1B is an explanatory diagram illustrating a configuration of the display device.

FIG. 2A is an explanatory diagram illustrating a design which is displayed on the display device in the first embodiment when light is not emitted from a light source and rotation of a dial is 0°.

FIG. 2B is an explanatory diagram illustrating the oscillation direction of a third polarizing plate in FIG. 2A.

FIG. 3A is an explanatory diagram illustrating a design which is displayed on the display device in the first embodiment when light is emitted from the light source and rotation of the dial is 0°.

FIG. 3B is an explanatory diagram illustrating the oscillation direction of the third polarizing plate in FIG. 3A.

FIG. 4A is an explanatory diagram illustrating a design which is displayed on the display device in the first embodiment when light is emitted from the light source and rotation of the dial is 45°.

FIG. 4B is an explanatory diagram illustrating the oscillation direction of the third polarizing plate in FIG. 4A.

FIG. 5A is an explanatory diagram illustrating a mirror device mounting a display device in the second embodiment.

FIG. 5B is an explanatory diagram illustrating an operation of the display device in the second embodiment to display a two-dimensional design.

FIG. SC is an explanatory diagram illustrating an operation of the display device in the second embodiment to display a three-dimensional design.

### DESCRIPTION OF EMBODIMENTS

### (Summary of the Embodiments)

A display device of the present embodiment comprises: polarization regions having a light transmittance varying from a first direction to a second direction orthogonal to the first direction depending on an oscillation direction of light such that a transmittance of light oscillating in the first direction is maximized and light oscillating in the second direction is blocked; design regions that are transparent to light regardless of the oscillation direction of light; a first polarizing plate comprising a first polarization region as one of the polarization regions and a first design region as one of the design regions; a second polarizing plate comprising a second polarization region as one of the polarization regions and a second design region as one of the design regions; and a third polarizing plate comprising a third polarization region as one of the polarization regions, wherein the first polarizing plate and the second polarizing plate are arranged at a distance from each other along a path of the light, the first direction in the first polarization region and the first direction in the second polarization region are different from each other, and wherein the third polarizing plate is arranged such that the first direction in the third polarization region is positioned between the first direction in the first polarization region and the first direction in the second polarization region.

The display device is configured such that designs on the first polarizing plate and the second polarizing plate, which are formed by light polarized by the third polarizing plate, are overlapped. Therefore, unlike the case where such configuration is not adopted, it is possible to display a three-dimensional design.

### First Embodiment

### (General Configuration of Display Device 1)

In each drawing for the embodiments, a scale ratio may be different from the actual ratio. In addition, the numerical range described as “A-B” means “not less than A and not more than B”. The lines on first to third polarizing plates 3 to 5 indicate the oscillation direction of light to be transmitted.

The display device 1 is used in an electric/electronic device such as an air conditioner or a navigation system mounted on a vehicle. The display device 1 also can be used as a device for, e.g., switching display between automated driving modes. As an example, the display device 1 in the first embodiment is to display on/off of a function of an air condo tioner.

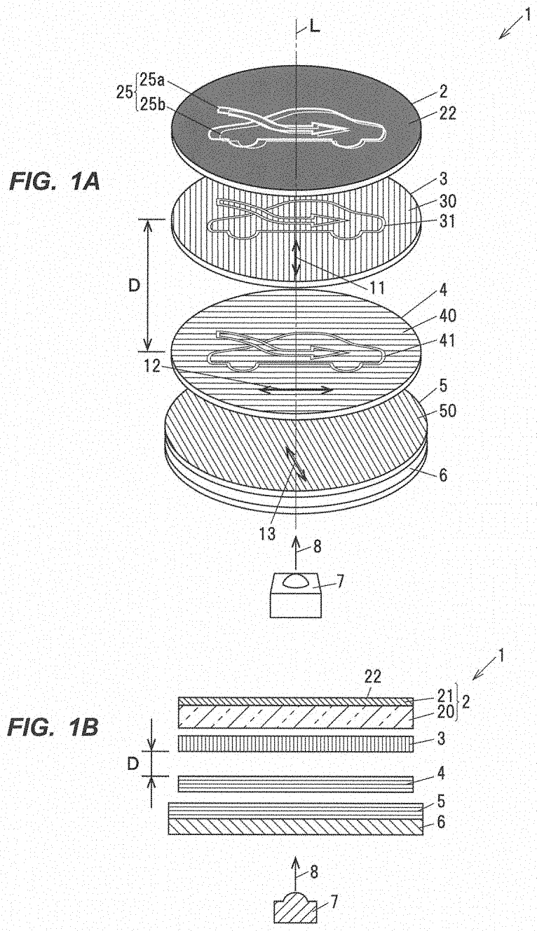

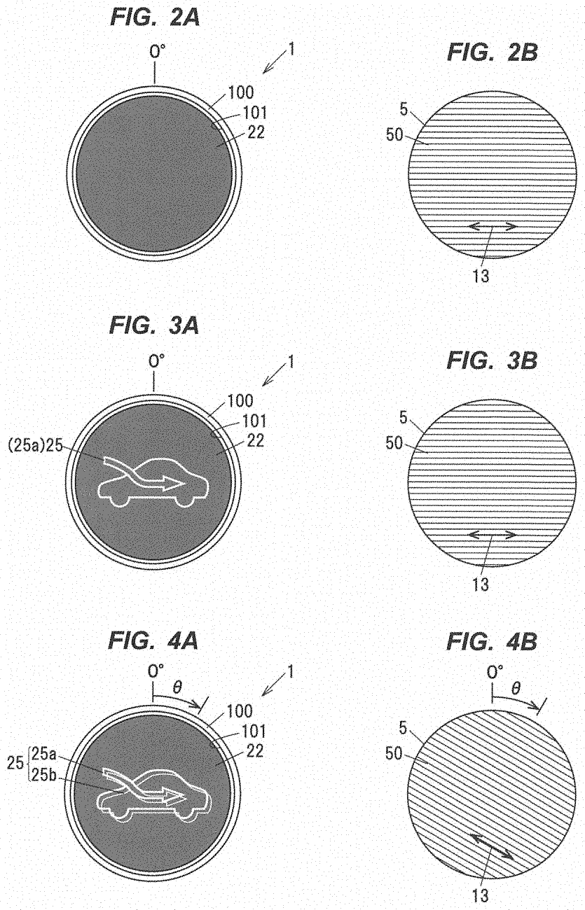

As shown in FIGS. 1A and 1B, the display device 1 is provided with, e.g., a display portion 2, a first polarizing plate 3, a second polarizing plate 4, a third polarizing plate 5, a diffusion layer 6 and a light source 7. The display device 1 is also provided with, e.g., a rotationally-operable dial 100, as shown in FIGS. 2A, 3A and 4A.

In the display device 1, polarization regions are regions having varying light transmittance from the first direction to the second direction orthogonal to the first direction depending on the oscillation direction of light in such a manner that a transmittance to light oscillating in the first direction is the highest and light oscillating in the second direction is blocked, and design regions are regions transparent to light regardless of the oscillation direction of light.

In more detail, the first polarizing plate 3 has, e.g., a first polarization region 30 as one of the polarization regions and a first design region 31 as one of the design regions, as shown in FIG. 1A. In the first polarizing plate 3, the first direction is a first oscillation direction 11 and the second direction is a second oscillation direction 11. Vertical lines on the first polarizing plate 3 shown in FIGS. 1A and 1B indicate that a transmittance to light oscillating in the first oscillation direction 11 is the highest.

The second polarizing plate 4 has, e.g., a second polarization region 40 as one of the polarization regions and a second design region 41 as one of the design regions, as shown in FIG. 1A. In the second polarizing plate 4, the first direction is the second oscillation direction 12 and the second direction is the first oscillation direction 11. Horizontal lines on the second polarizing plate 4 shown in FIGS. IA and 1B indicate that a transmittance to light oscillating in the second oscillation direction 12 is the highest.

The angle between the first direction of the first polarizing plate 3 and the first direction of the second polarizing plate 4 is not limited to the right angle as long as they intersect.

The third polarizing plate 5 has, e.g., a third polarization region 50 as one of the polarization regions, as shown in FIG. 1A. The diagonal lines on the third polarizing plate 5 shown in FIG. 1A indicate that light oscillating in an oscillation direction between the first oscillation direction 11 and the second oscillation direction 12 is selectively transmitted. The horizontal lines on the third polarizing plate 5 shown in FIG. 1B indicate that light oscillating in the second oscillation direction 12 is selectively transmitted. “Selectively transmitted” here means that transmittance to light oscillating in any other oscillation directions is substantially 0%.

The first polarizing plate 3 and the second polarizing plate 4 are arranged at a distance D from each other along a path of light 8 so that the first direction in the first polarization region 30 (the first oscillation direction 11) and the first direction in the second polarization region 40 (the second oscillation direction 12) are different from each other. In addition, the third polarizing plate 5 is arranged so that the first direction in the third polarization region 50 is positioned between the first direction in the first polarization region 30 and the first direction in the second polarization region 40. The path of the light 8 is, e.g., a path along an optical axis L shown in FIG. 1A.

For example, as shown in FIGS. 1A and 1B, a three-dimensional design 25 based on the first design region 31 and the second design region 41 is displayed on the display portion 2 by light transmitted through the third polarizing plate 5, the second polarizing plate 4 and the first polarizing plate 3 which are arranged in this order.

The three-dimensional design 25 here is a combination of a first design 25a formed by projecting the first design region 31 on the display portion 2 and a second design 25b formed by projecting the second design region 41 on the display portion 2 which are in different shapes due to the distance D and are overlapped with each other, and it is a design which appears as if it is 3D. In other words, a display from the first polarizing plate 3 and a display from the second polarizing plate 4, which are formed by removing the polarization properties, are overlapped and produce the three-dimensional design 25. The three-dimensional design 25 schematically shown in FIG. 1A, etc., is an example.

Removal of the polarization properties does not mean that only oscillating in a specific oscillation direction is transmitted or light is blocked, but it means that light is transmitted through both the first polarization region 30 and the second polarization region 40.

As a modification, the display portion 2 may be configured to display the three-dimensional design 25 which is based on the first design region 31 and the second design region 41 and is produced by light transmitted through the second polarizing plate 4, the first polarizing plate 3 and the third polarizing plate 5 which are arranged in this order. In this case, the diffusion layer 6 is arranged between the light source 7 and the second polarizing plate 4.

As described above, the first oscillation direction 11 and the second oscillation direction 12 are oscillation directions orthogonal to each other. The angle between the first oscillation direction 11 and the second oscillation direction 12 is not limited to the right angle as long as the oscillation directions are different from each other, but the right angle is preferable to perform more precise switching between the two-dimensional design 25 and the three-dimensional design 25.

The first oscillation direction 11 is, e.g., an oscillation direction indicated by the vertical arrow on the paper plane of FIG. 1A. The second oscillation direction 12 is, e.g., an oscillation direction indicated by the horizontal arrow on the paper plane of FIG. 1A. Furthermore, a third oscillation direction 13 is, e.g., a direction along the diagonal lines on third polarizing plate 5 on the paper plane of FIG. 1A.

The first design region 31 and the second design region 41 are arranged along the path of the light 8 so as to at least partially overlap with each other. in addition, the first design region 31 and the second design region 41 have the same shape. In other words, the first design region 31 and the second design region 41 are arranged at the distance D so as to at least partially overlap with each other along the optical axis L. The distance D is a distance which is required to form the three-dimensional design 25.

The third polarizing plate 5 is rotatable and transmits light oscillating in the first oscillation direction 11 or the second oscillation direction 12 so that the two-dimensional design 25 based on the first design region 31 or the second design region 41 is formed.

### (Configuration of the Display Portion 2)

As shown in FIGS. 1A and 1B, the display portion 2 is, e.g., a circular disc for displaying the design 25 and has a base portion 20 and a smoke layer 21.

The base portion 20 is formed of, e.g., a transparent resin. The smoke layer 21 is, e.g, a layer of a smoke film arranged of a front surface of the base portion 20, but is not limited thereto and may be formed by printing, etc. The smoke layer 21 is a layer having a low light transmittance and looks like black.

That is, for example, the display portion 2 when only with natural light and not illuminated shows only black color of the background and does not display the design 25, i.e., totally black, as shown in FIG. 2A. The surface of the display portion 2 is a display surface 22 for displaying the design 25.

### (Configuration of the First Polarizing Plate 3)

The first polarizing plate 3 has, e.g., a polarizing function and is formed in a circular plate shape. The first polarizing plate 3 is provided with, e.g., the first polarization region 30 and the first design region 31, as shown in FIG. 1A.

The first polarization region 30 is configured that a transmittance to light oscillating in the first oscillation direction 11 is the highest. As an example, the first polarization region 30 is configured that its transmittance continuously changes with a change in the oscillation direction and a transmittance to light inclined at 45° relative to the first oscillation direction 11 is 50%. A transmittance to light oscillating in the oscillation direction orthogonal to the first oscillation direction 11 is substantially 0%.

The first design region 31 is formed by, e.g., partially removing the polarizing function of the first polarization region 30 using laser, etc. The first design region 31 is a region transparent to light which is incident thereon through the diffusion layer 6, the third polarizing plate 5 and the second polarizing plate 4. in addition, the shape of the first design region 31 is a symbol of the function turned on/off by the display device 1.

### (Configuration of the Second Polarizing Plate 4)

The second polarizing plate 4 has, e.g., a polarizing function and is formed in a circular plate shape. The second polarizing plate 4 is provided with, e.g., the second polarization region 40 and the second design region 41, as shown in FIG. 1A.

The second polarization region 40 is configured that a transmittance to light oscillating in the oscillation direction the second oscillation direction 12 is the highest. As an example, the second polarization region 40 is configured that its transmittance continuously changes with a change in the oscillation direction and a transmittance to light inclined at 45° relative to the second oscillation direction 12 is 50%. A transmittance to light oscillating in the oscillation direction orthogonal to the second oscillation direction 12 is substantially 0%.

The second design region 41 is formed by, e.g., partially removing the polarizing function of the second polarization region 40 using laser, etc. The second design region 41 is a region transparent to light which is incident thereon through the diffusion layer 6 and the third polarizing plate 5. in addition, the shape of the second design region 41 is a symbol of the function turned on/off by the display device 1.

As described above, the shape of the second design region 41 is the same as the shape of the first design region 31. Alternatively, as a modification, one of the first design region 31 and the second design region 41 may be diminished or enlarged in scale or the shapes thereof may be different from each other. In addition, when the second design region 41 is larger than the shape of the first design region 31, the design 25 becomes more three-dimensional than when both have the same shape. The shape here includes not only the entire figure but also the thickness of line.

Also as a modification, the display device 1 can display the three-dimensional design 25 by forming shapes of different parts respectively on the first polarizing plate 3 and the second polarizing plate 4.

### Configuration of the Third Polarizing Plate 5)

The third polarizing plate 5 is, e.g., formed to have a larger diameter than the display portion 2, the first polarizing plate 3 and the second polarizing plate 4, is attached to the dial 100, and is configured to rotate with the dial 100. The third polarizing plate 5 has the third polarization region 50 which is only transparent to light oscillating in the third oscillation direction 13.

That is, the third polarizing plate 5 is configured to absorb, e.g., light oscillating in oscillation directions other than the third oscillation direction 13 by the third polarization region 50. Therefore, light transmitted through the third polarizing plate 5 is linearly polarized light having a polarization component oscillating in the third oscillation direction 13. As a modification, the third polarizing plate 5 may be not only configured to transmit only light oscillating in the third oscillation direction 13 but also configured that a transmittance to light oscillating in the third oscillation direction 13 is the highest.

The third oscillation direction 13 is preferably in a range of, e.g., 30°-60° relative to the second oscillation direction 12. This range is an angle rotated at ±15° from 45°. In the first embodiment, the third oscillation direction 13 is at 45° which is an angle based on the detent of the dial 100 and rotated 15° from the second oscillation direction 12.

### (Configuration of the Diffusion Layer 6)

The diffusion layer 6 is formed in, e.g., a circular plate shape having the same diameter as the third polarizing plate 5. Although the diffusion layer 6 here is attached to the third polarizing plate 5 and is configured to rotate with the dial 100, it is not limited thereto. The diffusion layer 6 may be attached to another member and configured to not rotate with the dial 100.

The diffusion layer 6 is formed of a transparent resin transparent to light and contains particles (diffusing agent) which are dispersed therein and have a different refractive index from the transparent resin. The diffusion layer 6 is transparent to the light 8 output from the light source 7 and diffuses the light 8 so that the light 8 can be uniformly incident on the third polarizing plate 5.

### (Configuration of the Light Source 7)

The light source 7 is constructed from, e.g., an LED (Light-Emitting Diode) element or a laser element. Plural light sources 7 may be provided.

### (Configuration of the Dial 100)

The dial 100 is formed in, e.g., a circular cylindrical shape and has a cylinder hole 101 in which the display portion 2, the first polarizing plate 3, the second polarizing plate 4, the third polarizing plate 5 and the diffusion layer 6 are arranged. The display portion 2, the first polarizing plate 3 and the second polarizing plate 4 do not rotate with the operated dial 100.

It is configured to switch between the two-dimensional design 25 (the planar design) and the three-dimensional design 25 (the stereoscopic design) based on, e.g., an operated amount (a rotated amount θ) of the dial 100. in the first embodiment, when the rotated amount θ of the dial 100 is 0°, e.g., the two-dimensional design 25 is displayed as shown in FIG. 3A. Then, when the rotated amount θ of the dial 100 is 45°, e.g., the three-dimensional design 25 is displayed as shown in FIG. 4A. The dial 100 has detents at positions at which the rotated amount θ is, e.g., 0° and 45°.

Next, an operation of the display device 1 in the first embodiment to switch between the two-dimensional design 25 and the three-dimensional design 25 will be described.

### (Operation)

### (Before Displaying the Design 25)

FIG. 2A shows the state when the light 8 is not emitted from the light source 7 and the operated amount (the rotated amount θ) of the dial 100 is 0°. As shown in FIG. 2B, the third oscillation direction 13 of the d polarizing plate 5 in this state coincides with the second oscillation direction 12 in which the light transmittance of the second polarizing plate 4 is the highest.

### (Two-Dimensional Design 25)

FIG. 3A shows the state when the light 8 is emitted from the light source 7 and the operated amount (the rotated amount θ) of the dial 100 is 0°. As shown in FIG. 3B, the third oscillation direction 13 of the third polarizing plate 5 in this state coincides with the second oscillation direction 12 of the second polarizing plate 4.

Thus, the light 8 output from the light source 7 is polarized by the third polarizing plate 5 to oscillate in the third oscillation direction 13. This polarized light is light oscillating in the same oscillation direction as the second oscillation direction 12 providing the highest transmittance of the second polarizing plate 4 and is thus transmitted through not only the second design region 41 but also the second polarization region 40. In other words, the light polarized by the third polarizing plate 5 is transmitted through the entire second polarizing plate 4 and is then incident on the first polarizing plate 3.

The first polarizing plate 3 is transparent mainly to light oscillating in the first oscillation direction 11. Substantially no light is transmitted through the first polarization region 30 due to its oscillation direction orthogonal to the first oscillation direction 11, and light transmitted through the first design region 31 is incident on the display portion 2. Then, the light transmitted through the first design region 31 produces the two-dimensional design 25 displayed on the display surface 22 of the display portion 2.

This two-dimensional design 25 (the first design 25a) is formed by the light transmitted through the first design region 31. In the first embodiment, the two-dimensional design 25 is displayed when the vehicle is powered on and the light 8 is emitted from the light source 7.

### (Three-Dimensional Design 25)

FIG. 4A shows the state when the light 8 is emitted from the light source 7 and the operated amount (the rotated amount θ) of the dial 100 is 00°. As shown in FIG. 4A, the third oscillation direction 13 of the third polarizing plate 5 in this state is changed to 45° according to the rotated amount θ of the dial 100, as shown in FIG. 4B.

The light 8 output from the light source 7 is polarized by the third polarizing plate 5 to oscillate in the third oscillation direction 13. This polarized light is light oscillating in the oscillation direction inclined at 45° relative to the second oscillation direction 12 providing the highest transmittance of the second polarizing plate 4, and is thus transmitted through the second design region 41 and is also transmitted through the second polarization region 40 at a transmittance of 50%.

The light transmitted through the second polarizing plate 4 is transmitted through the first polarization region 30 at a transmittance of 50% and is also transmitted through the first design region 31.

Then, the light transmitted through the second design region 41 reaches the first polarizing plate 3 in a different shape, etc., due to the distance D between the first polarizing plate 3 and the second polarizing plate 4 and is then incident on the first polarization region 30 and the first design region 31, The light incident on the first polarization region 30 in this case is transmitted at a transmittance of 50%, as described above.

Thus, the first design 25a projected on the display portion 2 by the light transmitted through the first design region 31 and the second design 25b slightly misaligned with the first design 25a are displayed on the display surface 22 of the display portion 2, and the three-dimensional design 25 is displayed as a combination of these two (the first design 25a and the second design 25b).

### (Effects of the First Embodiment)

The display device 1 in the first embodiment can three-dimensionally display the design 25. In detail, in the display device 1, the design 25a and the second design 25b on the first polarizing plate 3 and the second polarizing plate 4, which are formed by removing the polarization properties and using light polarized by the third polarizing plate 5, are overlapped and displayed as the design 25 on the display portion 2. Therefore, unlike when such configuration is not adopted, it is possible to three-dimensionally display the design 25.

The display device 1 has the first polarizing plate 3 and the second polarizing plate 4 arranged at the distance D and thus can display a deeper three-dimensional design 25 than when not having the intentionally provided distance.

In the display device 1, the oscillation direction permitting the passage of light can be changed by rotating the third polarizing plate 5. Therefore, unlike when such configuration is not adopted, it is possible to easily switch between the two-dimensional design 25 and the three-dimensional design 25 by rotating the dial 100. Therefore, when the display device 1 is used in an electric/electronic device such as an air conditioner, it is possible to manually switch between the two-dimensional design 25 and the three-dimensional design 25, it is easy to visually recognize switching of the function such as on/off, and it is possible to reduce the cost as compared to when using switching control.

### Second Embodiment

The second embodiment is different from the first embodiment in that the two-dimensional design and the three-dimensional design are formed based on switching of light sources. In the second embodiment, portions having the same function and structure as those in the first embodiment are denoted by the same reference numerals and the explanation thereof will be omitted.

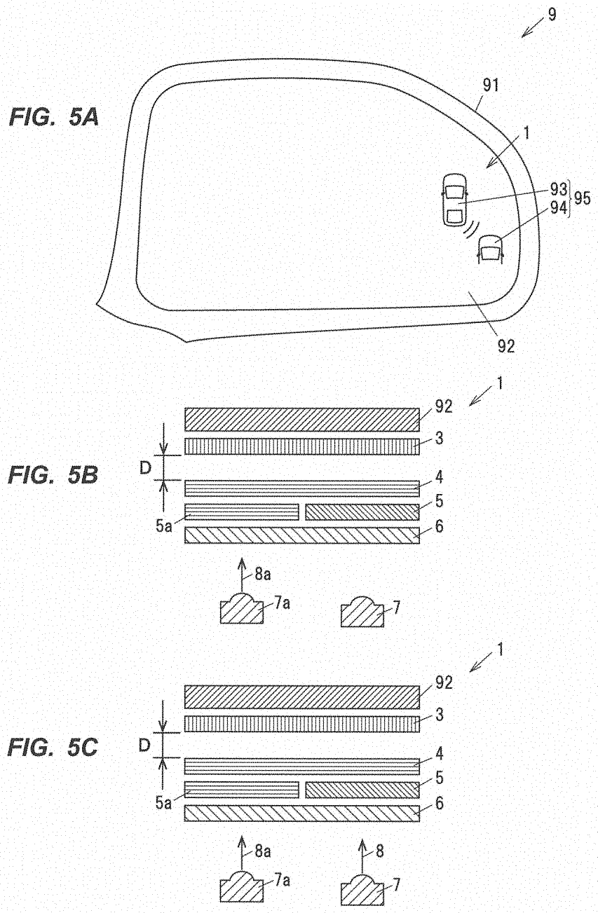

FIG. 5 shows an example of a mirror device 91 of a vehicle 9. In the vehicle 9, a warning 95 is displayed on a mirror 92 of the mirror device 91 when another vehicle is coming close to the vehicle 9. The warning 95 has, e.g., a first design 93 indicating own vehicle and a second design 94 indicting another vehicle.

As shown in FIGS. 5B and 5C, the display device 1 in the second embodiment is further provided with, e.g, a fourth polarizing plate 5a having a fourth polarization region as one of the polarization regions in case that the third polarizing plate 5, the second polarizing plate 4 and the first polarizing plate 3 are arranged in this order. The fourth polarizing plate 5a is arranged side-by-side with the third polarizing plate 5 in a direction orthogonal to a direction along the path of the light within a range where the first direction in the fourth polarization region is regarded as being coincident with the first direction in the first polarization region 30 or the first direction in the second polarization region 40. The fourth polarizing plate 5a is provided with only a polarization region.

The display device 1 is also provided with the diffusion layer 6, the light source 7 outputting the light 8 through the third polarizing plate 5, and a light source 7a outputting light 8a through the fourth polarizing plate 5a.

In this display device 1, the two-dimensional design is displayed on the mirror 92 when light is output through the fourth polarizing plate 5a, and the three-dimensional design is displayed on the mirror 92 when light is output through the third polarizing plate 5 and the fourth polarizing plate 5a. In detail, for example, according to an instruction from the vehicle 9, the display device 1 switches between output of only the light 8 from the light source 7 and output of both the light 8 from the light source 7 and the light 8a from the light source 7a, thereby switching between the two-dimensional warning 95 and the three-dimensional warning 95.

The fourth polarizing plate 5a in the second embodiment is configured so that light oscillating in the second oscillation direction 12, which is the same oscillation direction as that of the second polarizing plate 4, is selectively transmitted, i.e., so that the entire region on the path of light acts as the fourth polarization region. Thus, projection of the first design region 31 of the first polarizing plate 3 is the two-dimensional warning 95.

In this case, the first design region 31 of the first polarizing plate 3 has the shapes of the first design 93 and the second design 94, and the second design region 41 of the second polarizing plate 4 has the shape of the second design 94.

In case that the fourth polarizing plate 5a is selectively transparent to light oscillating in the first oscillation direction 11 which is the same oscillation direction as that of the first polarizing plate 3, the second design region 41 of the second polarizing plate 4 is projected when the light 8a is output from the light source 7a.

### (Two-Dimensional Warning 95 and Three-Dimensional Warning 95)

When another vehicle is away at not less than a predetermined distance but within the warning range, the display device 1 outputs, e.g., the light 8a from the light source 7a as shown in FIG. 5B and displays the two-dimensional warning 95.

In detail, since the light 8a is transmitted through the fourth polarizing plate 5a of which the oscillation direction is the same as that of the second polarizing plate 4, the first design region 31 of the first polarizing plate 3 is projected on the mirror 92, thereby producing the warning 95 which is the two-dimensional design.

Meanwhile, when another vehicle is coming closer than the predetermined distance, the display device 1 additionally outputs, e.g., the light 8 from the light source 7 as shown in FIG. 5C, thereby displaying the warning 95 which is the three-dimensionally displayed second design 94.

In detail, the display device 1 outputs the light 8 from the light source 7, in addition to the light 8a from the light source 7a. The light 8 is incident on the third polarizing plate 3 and is then incident, as the light polarized to oscillate in third oscillation direction 13, on the second polarizing plate 4, and the second design region 41 second polarizing plate 4 together with the first design region 31 is projected on the mirror 92. Thus, in the display device 1, the first design region 31 and the second design region 41 are overlapped and projected onto the mirror 92 and the three-dimensional warning 95 is displayed.

As a modification, the display device 1 may be configured to switch between the two-dimensional warning 95 and the three-dimensional warning 95 by blinking the light source 7 to allow easier visual recognition.

### (Effects of the Second Embodiment)

The display device 1 in the second embodiment can display the two-dimensional warning 95 by illumination using only the light source 7 and can display the three-dimensional warning 95 by illumination using the light source 7 and the light source 7a. Therefore, unlike when such configuration is not adopted, it is possible to easily switch between the two-dimensional warning 95 and the three-dimensional warning 95.

Although some embodiments and modifications of the invention have been described above, the embodiments and modifications are merely an example and the invention according to claims is not to be limited thereto. These new embodiments and modifications may be implemented in various other forms, and various omissions, substitutions and changes, etc., can be made without departing from the gist of the invention. In addition, all combinations of the features described in the embodiments and modifications are not necessary to solve the problem of the invention. Further, these embodiments and modifications are included within the scope and gist of the invention and also within the invention described in the claims and the equivalency thereof.

### REFERENCES SIGNS LIST

1 DISPLAY DEVICE
2 DISPLAY PORTION
3 FIRST POLARIZING PLATE
4 SECOND POLARIZING PLATE
5 THIRD POLARIZING PLATE
5a FOURTH POLARIZING PLATE
8, 8a LIGHT
30 FIRST POLARIZATION REGION
31 FIRST DESIGN REGION
40 SECOND POLARIZATION REGION
41 SECOND DESIGN REGION
50 THIRD POLARIZATION REGION

1. A display device, comprising:
polarization regions having a light transmittance varying from a first direction to a second direction orthogonal to the first direction depending on an oscillation direction of light such that a transmittance of light oscillating in the first direction is maximized and light oscillating in the second direction is blocked;
design regions that are transparent to light regardless of the oscillation direction of light;
a first polarizing plate comprising a first polarization region as one of the polarization regions and a first design region as one of the design regions;
a second polarizing plate comprising a second polarization region as one of the polarization regions and a second design region as one of the design regions; and
a third polarizing plate comprising a third polarization region as one of the polarization regions,
wherein the first polarizing plate and the second polarizing plate are arranged at a distance from each other along a path of the light, the first direction in the first polarization region and the first direction in the second polarization region are different from each other, and
wherein the third polarizing plate is arranged such that the first direction in the third polarization region is positioned between the first direction in the first polarization region and the first direction in the second polarization region.

2. The display device according to claim 1, wherein the first polarization region and the second polarization region are arranged along the path of the light so as to at least partially overlap with each other.

3. The display device according to claim 1, wherein the first direction in the first polarization region is orthogonal to the first direction in the second polarization region.

4. The display device according to claim 1, wherein the first polarization region is configured that the transmittance to light oscillating in a direction inclined at 45° from the first direction in the first polarization region is 50%, and the second polarization region is configured that the transmittance to light oscillating in a direction inclined at 45° from the first direction in the second polarization region is 50%.

5. The display device according to claim 1, wherein the third polarization region is only transparent to light oscillating in the first direction in the third polarization region.

6. The display device according to claim 1, wherein the first direction in the third polarization region is in a range of 30°-60° relative to the first direction in the second polarization region.

7. The display device according to claim 1, wherein the first design region and the second design region have the same shape.

8. The display device according to claim 1, wherein the third polarizing plate is configured to be rotatable.

9. The display device according to claim 8, wherein the third polarizing plate is transparent to light oscillating in the first direction in the first polarization region or the first direction in the second polarization region when rotated and located at a position at which the first direction in the third polarization region coincides with the first direction in the first polarization region or the first direction in the second polarization region.

10. The display device according to claim 1, further comprising:
a fourth polarizing plate comprising a fourth polarization region as one of the polarization regions when the third polarizing plate, the second polarizing plate and the first polarizing plate are arranged in this order,
wherein the fourth polarizing plate is arranged side-by-side with the third polarizing plate in a direction orthogonal to a direction along the path of the light within a range where the first direction in the fourth polarization region is regarded as being coincident with the first direction in the first polarization region or the first direction in the second polarization region.
